(19) United States
(12) Patent Application Publication
(10) Pub. No.: US 2007/0202470 A1
(43) Pub. Date: Aug. 30, 2007

(54) INTEGRATED INSTRUCTOR STATION FOR A SIMULATOR

(76) Inventor: Fernando Petruzziello, Montréal, QC (CA)

Correspondence Address: BERESKIN AND PARR, 40 KING STREET WEST, BOX 401, TORONTO, ON, M5H 3Y2, CA

(21) Appl. No.: 11/558,679

(22) Filed: Nov. 10, 2006

Related U.S. Application Data
(63) Continuation-in-part of application No. PCT/CA05/00746, filed on May 10, 2005.

(30) Foreign Application Priority Data
May 10, 2004 (CA) 2467008

(51) Int. Cl. G09B 9/02

(52) U.S. Cl. 434/29

(57) ABSTRACT

An instructor station for a simulator comprises an instructor seat having a base, a support structure and a console. The support structure is connected to the base. The console includes a display and controls for controlling a simulation performed by the simulator. The console is connected to the support structure. The support structure and the console are functionally located on a side of the instructor seat. A simulator training system comprises a floor, a trainee area and an instructor station. The trainee area has at least one trainee seat connected to the floor while the instructor station is displaceable on the floor.

This application is a continuation-in-part of International Patent Application No. PCT/CA2005/000746 filed on May 10, 2005, which claims priority from Canadian Patent Application No. 2,467,008, all of which are hereby incorporated by reference.

### FIELD OF THE INVENTION

The present invention generally relates to the field of computer-aided training devices of the type commonly referred to as simulators and, in particular, to the type of training devices which include an onboard instructor's console. Training devices of this type include simulators for vehicles such as transport aircraft, ships and large land vehicles and simulators for fixed station facilities such as power generators and chemical processes. More specifically, the invention relates to an instructor station for a simulator integrating the console and the displays.

### BACKGROUND OF THE INVENTION

Training devices or simulators present situations to a trainee to allow the trainee to practice some task, such as operating an airplane. In an aircraft simulator, for example, a pilot trainee sits in a reproduction of a real aircraft cockpit. An instructor influences the unfolding of the training mission by interacting with the computer which is managing the simulation. There are basically three types of simulators used for training purposes; those having no instructor console, those having an instructor's console outside the simulator and those where the instructor's console is onboard. An example of the second type is a simulator for high performance aircraft, usually of the single-seat variety. The present invention is specifically directed to the type of simulator where an instructor or senior crew member is on board the simulator with the trainees as part of the training mission. This would include any crew served vehicles but could include other training environments such as power plants, refining plants and the like.

The prior parallel configuration that supported instructor station facilities contained displays with adjacent switch panels as part of the instructor's console. The instructor was located console away from the trainees' positions. The arrangement was such that the instructor would have to sit at the instructor's console to control the training environment and then move to a position behind the trainees to observe the trainees' actions. In this latter position, the instructor could also observe the visual scene presented to the trainees, but when sitting at the instructor's console, the visual scene, including any instrumentation, was not readily observed by the instructor. Therefore, it was necessary to replicate much of the training environment at the instructor's console.

U.S. Pat. No. 5,224,861 to Glass et al. discloses an instructor station having integral console including a display. Hence, the instructor may control the simulation while always observing the trainees. However, the console is not ideally located to allow the instructor to take notes during the simulation. Indeed, the instructor has to lay his notebook and papers over the console, momentarily hiding all information and preventing interaction through the console. During the simulation, the instructor has to continuously remove his notebook from the console and put it back on to take more notes. Furthermore, because the console is required to act as a table, its orientation with respect to the eyes of the instructor is less than optimal. Moreover, the size and the position of the console prevent the instructor to place his seat very close to the trainee seats such as to get a good view of the controls in front of the trainees and of the trainee's actions.

There is therefore a need for an improved instructor station for a simulator that allows to continuous observation and control of the simulation. These is also a need for an improved instructor station permitting a good observation of the controls in front of the trainees and of the trainee's actions.

### SUMMARY OF THE INVENTION

It is an object of the invention to provide an instructor station that solves the problems of prior art.

It is a further object of the invention to provide an instructor station that allows uncluttered observation of the displays and uninterrupted control of the simulation while still allowing taking notes without unnecessary manipulation.

It is a further object of the invention to provide the instructor with a close observation position such that the instructor has a good view of the controls and of the trainee actions while remaining in visual and tactile reach of his console.

In accordance with an embodiment of the present invention, there is provided an instructor station for a simulator. The instructor station comprises an instructor seat having a base, a support structure and a console. The support structure is connected to the base. The console includes a display and controls for controlling a simulation performed by the simulator. The console is connected to the support structure. The support structure and the console are functionally located on a side of the instructor seat. The display may have one or more screens. The display is ergonomically located such as to be within visual reach by the instructor sitting on his seat. Preferably, the display is placed substantially at the instructor's eye level. Optionally, the support structure may be adjustable in height and longitudinally displaceable on the side of the instructor seat. The instructor station may comprise means to displace the base of the instructor seat on the floor of the simulator. These means to displace are adapted to roll on a track placed on the floor. Preferably, the instructor station comprises a writing surface attached to the instructor seat and placed on the side of the instructor seat opposite to the display assembly. The writing surface is operatively located in front of the instructor when sitting on his seat.

In accordance with another embodiment of the present invention, there is provided a simulator training system. The simulator training system comprises a floor, a trainee area and an instructor station. The trainee area has at least one trainee seat connected to the floor while the instructor station is displaceable on the floor. The instructor station is displaceable from a first position located away from the trainee area to a second position in the trainee area. The second position is located at least partially behind the at least one trainee seat and laterally offset from this trainee seat. The first position is located behind a trainee seat and adjacent a lateral wall of the simulator. Preferably, the instructor station is displaceable on tracks attached to a floor of the simulator. More preferably, the simulator is further equipped with a writing surface attached to the instructor seat.

In accordance with yet another embodiment of the present invention, there is provided a method of training using a simulator. The training method comprises the steps of a) positioning side-by-side two trainee seats in front of controls; b) positioning an instructor seat between and at least partially behind the two trainee seats such that instructor's feet project in front of the back of the two trainee seats; c) positioning a console adjacent and in a space immediately behind one of the two trainee seats and laterally adjacent to the instructor seat. The instructor so seated on his instructor seat assumes a close observation position and has an adequate view of the controls and of the actions of trainees sitting in the two trainee seats, while still having tactile and visual access to the console. Preferably, the method further comprises a step of moving the instructor seat away from the two trainee seats such that the instructor sitting in the instructor seat may assume a remote observation position. More preferably, the console is moved together with the instructor seat.

One of the advantages of the present invention is to provide an instructor with an instructor station allowing uncluttered observation of the displays and uninterrupted control of the simulation while still allowing taking notes without unnecessary manipulation. Positioning the console on the side of the instructor seat provides the advantage of being capable of getting the instructor station closer to the trainee seats than was possible with the prior art, while still retaining tactile and visual access to the console.

### BRIEF DESCRIPTION OF DRAWINGS

These and other features of the present invention will become more apparent from the following description in which reference is made to the appended drawings wherein:

FIG. 1 is an isometric view of an instructor station in accordance with an embodiment of the present invention.

FIG. 2 is a top view of the instructor station of FIG. 1 in a simulator.

FIG. 3 is a side view of the instructor station of FIG. 1.

FIG. 4 is a top view of an instructor station in accordance with another embodiment of the present invention.

### DETAILED DESCRIPTION OF THE INVENTION

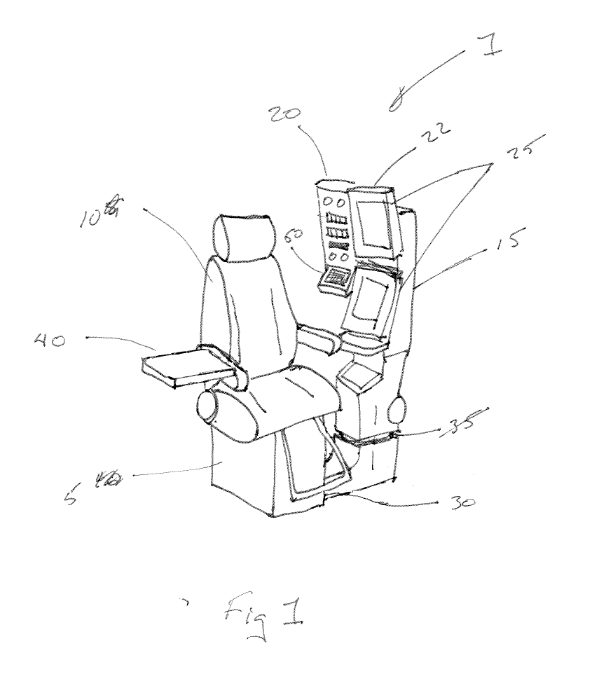

FIG. 1 generally shows an instructor station 1. The instructor station 1 comprises a base 5 supporting a seat 10. A support structure 15 is attached to a side of the base 5. The support structure 15 supports a console 20 including a display 22. The display 22 is equipped with at least one screen, or two screens 25 as shown in FIG. 1, that display to the instructor information about the simulation being performed. The screens 25 are placed above each other and are ergonomically placed more or less at the instructor's eye level when seated in the seat 10. Both screens are equipped with a pivot mechanism such that they may be oriented towards the instructor. The support structure 15 is provided with a sliding means 30 allowing a longitudinal fore and aft movement of the support structure 15 with respect to the base 5. The instructor station 1 is also provided with a writing surface 40 placed on the side opposite to the support structure 15. This conveniently allows the instructor to take notes on the writing surface 40 and then leave his notebook and other papers there while turning his head on the opposite side of the seat 10 to verify the screens 25, or to input instructions using the console 20. The writing surface may also be arranged such as to be positioned in front of the instructor when deployed. Whether it is deployed on the side of the seat 10 or in front of the instructor, the writing surface 40 may optionally be stowed on the side of the seat 10. The writing surface 40 is sufficiently large to provide adequate writing surface while not being too large to come into contact with the trainee seats 65. Conveniently, the support structure 15 and the writing surface 40 may trade sides depending on preferences. The console 20 is also equipped with a keyboard 50 for inputting instructions.

Optionally, a display 22 may comprise a touch screen such that all information is displayed on the touch screen and all instructions are provided through the touch screen as well. For that purpose, a track ball may also be provided, depending on preferences.

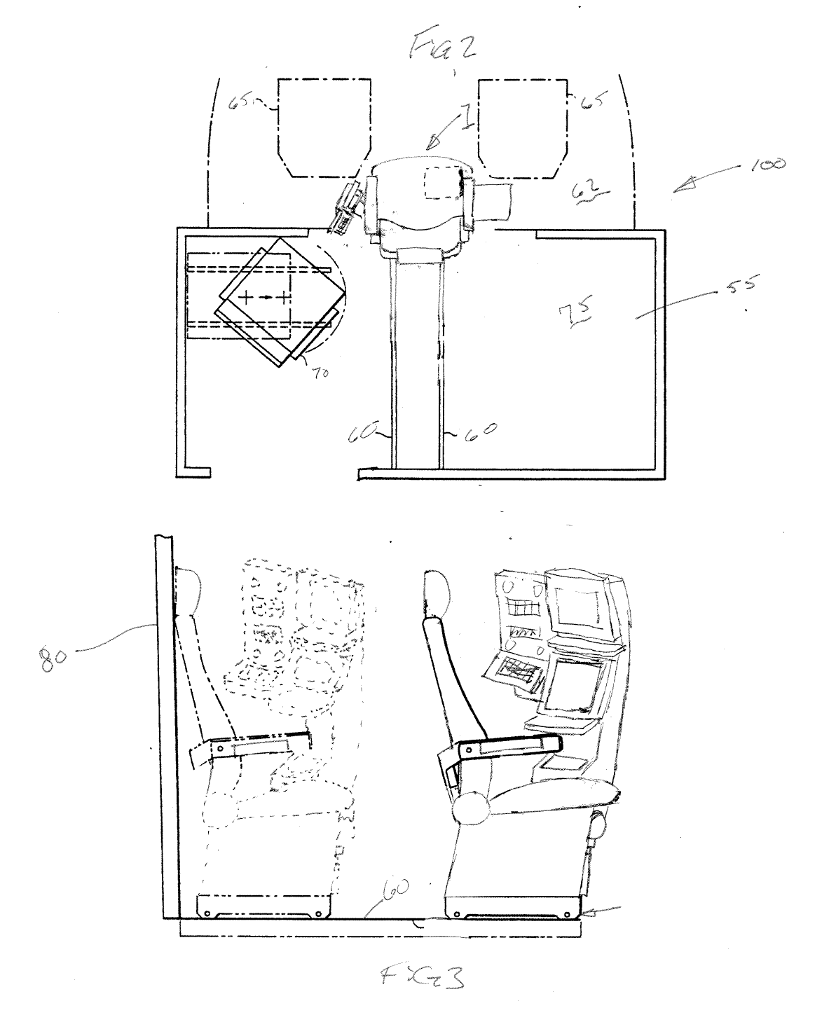

Turning now to FIG. 2 there is shown the instructor station 1 in its working environment such as a flight simulator 100. The floor 55 of the flight simulator 100 is equipped with tracks 60. The instructor station 1 is equipped with wheels for rolling on the tracks 60. Conveniently, the instructor station 1 is displaceable from the first position located away from a trainee area 62 to a second position close to, and in between, the trainee seats 65, located in the trainee area 62. This close observation position, offset from and higher than the trainee seats 65, allows the instructor an over the shoulder observation point of both the trainees and the simulation. Positioning the console 20 on the side of the seat 10 provides the advantage of being capable of getting the instructor station 1 close to the trainee seats 65. Indeed, what used to be an empty space behind the trainee seats 65 is now occupied by the console 20 and the writing surface 40. The tracks 60 stop such that it is impossible for the instructor station 1 to contact the trainee seats 65. Conveniently, the support structure 15 may be located either on the left hand side of the instructor station 1, or on its right hand side. In that case, the writing surface 40 is switched sides such as to always be opposite from the support structure 15, or is flipped in front of the instructor. Moving the instructor station 1 away from the trainee seats 65 permits easy ingress and egress from the trainee seats 65. An observer seat 70 is located in the instructor area 75.

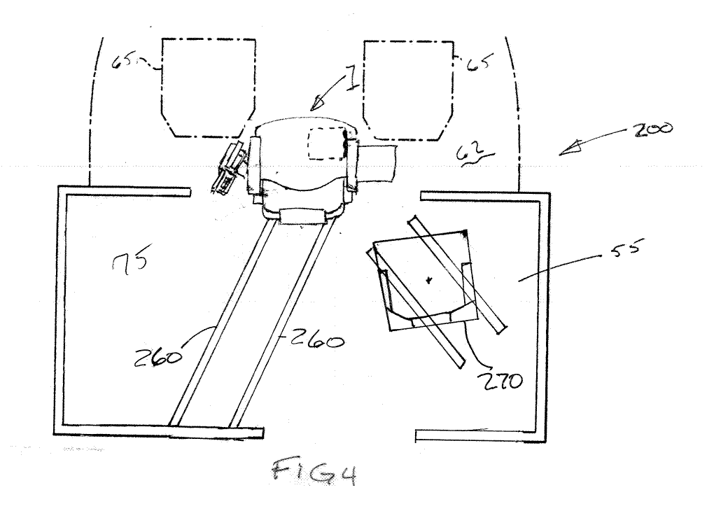

In FIG. 3, the instructor station 1 is shown being displaced from a position close to a wall 80, in the instructor area 75, to a second position closer to the trainee seats 65. Again, the support structure 15 is shown on the left hand side of the instructor station 1. The console 20 is placed with easy reach from the instructor. The screen 25, which may be LCD panels, are tilted such as to be easily seen by the instructor. The writing surface 40 may be of a foldable type such as to be conveniently stowed away.

In use, the instructor takes place in the seat 10 of the instructor station 1 when it is in its first position close to the wall 80. The instructor then moves the instructor station 1 to the end of the tracks 60, in the close observation position, such that the console 20 and support structure 15 takes up the space immediately at the back of either the pilot or the co-pilot trainee seat 65. The instructor deploys the writing surface 40 either to his side or right in front of him. In the close observation position, the instructor gets a good view of most of the controls facing the trainees. He also gets a good view of the actions of the trainees. In this position, the instructor may place his feet in between the trainee seats 65. During the simulation, the instructor may assume a remote observation position, away from the trainee seats 65 such as to get a more global view of the simulation environment.

Turning now to FIG. 4, there is shown the instructor station 1 in another working environment such as a flight simulator 200. The floor 55 of the flight simulator 100 is equipped with tracks 260. The instructor station 1 is equipped with wheels for rolling on the tracks 260. Conveniently, the instructor station 1 is displaceable from the first position located away from a trainee area 62 and on a side of the instructor area 75 to a second position close to, and in between, the trainee seats 65, located in the trainee area 62. Being able to displace the instructor station 1 away from a center region of instructor area 75 provides more room for an observer seat 270 located in the instructor area 75. The close observation position, offset from and higher than the trainee seats 65, allows the instructor an over the shoulder observation point of both the trainees and the simulation. The tracks 260 stop such that it is impossible for the instructor station 1 to contact the trainee seats 65. Moving the instructor station 1 away from the trainee seats 65 permits easy ingress and egress from the trainee seats 65. An observer seat 70 is

It will be readily apparent to a person skilled in the art that variations in the disposition of the simulator may be used depending on the type of simulator. For instance, a simulator for a ship will have a different disposition than a disposition for an aircraft or for a nuclear power plan. Nevertheless, the instructor station 1 of the present invention may be used in all these different types of simulators. Another variation may be to attach a console 20 to the back of one of the trainee seats 65.

Other variations to the invention may include using only one screen to provide information to the instructor or alternatively, more than the two described screens.

The present invention has been described with regard to preferred embodiments. The description as much as the drawings were intended to help the understanding of the invention, rather than to limit its scope. It will be apparent to one skilled in the art that various modifications may be made to the invention without departing from the scope of the invention as described herein, and such modifications are intended to be covered by the present description.

I claim:

1. An instructor station for a simulator comprising:
an instructor seat having a base;
a support structure connected to said base;
a console including a display and controls, for controlling a simulation performed by the simulator, said console being connected to said support structure;
wherein said support structure and said console are functionally located on a side of said instructor seat.

2. A station as defined in claim 1 wherein said display is ergonomically located so as to be visible by an instructor sitting on said instructor seat.

3. A station as defined in claim 2 wherein said display is placed substantially at an eye level.

4. A station as defined in claim 2 wherein said support structure is adjustable in height.

5. A station as defined in claim 2 wherein said support structure is longitudinally displaceable on said side of said instructor seat.

6. A station as defined in claim 1 further comprising means to displace said base of said instructor seat on a floor.

7. A station as defined in claim 6 wherein said means to displace are adapted to roll on a track placed on the floor.

8. A station as defined in claim 1 further comprising a writing surface attached to said instructor seat.

9. A station as defined in claim 8 wherein said writing surface is placed on a side of said instructor seat opposite to said display assembly.

10. A station as defined in claim 8 wherein said writing surface is operatively located in front of an instructor sitting on said instructor seat.

11. A station as defined in claim 1 wherein said display has two screens.

12. A simulator training system comprising:
a floor;
a trainee area having at least one trainee seat connected to said floor;
an instructor station having:
an instructor seat having a base;
a support structure connected to said base;
a console including a display and controls, for controlling a simulation performed by the simulator, said console being connected to said support structure;
wherein said support structure and said console are functionally located on a side of said instructor seat and said instructor station is displaceable on said floor.

13. A simulator as defined in claim 12 wherein said instructor station is displaceable from a first position located away from said trainee area to a second position in said trainee area.

14. A simulator as defined in claim 13 wherein said second position is located at least partially behind said at least one trainee seat and laterally offset from said at least one trainee seat.

15. A simulator as defined in claim 14 wherein said first position is located behind a trainee seat and adjacent a lateral wall of said simulator.

16. A simulator as defined in claim 14 wherein said instructor station is displaceable on tracks attached to a floor of said simulator.

17. A simulator as defined in claim 12 further comprising a writing surface attached to said instructor seat.

18. A method of training using a simulator comprising the steps of:
positioning side-by-side two trainee seats in front of controls;
positioning an instructor seat between and at least partially behind said two trainee seats so that instructor's feet project in front of the back of said two trainee seats;
positioning a console adjacent and in a space immediately behind one of said two trainee seats and laterally adjacent to said instructor seat;
so that an instructor sitting on said instructor seat assumes a close observation position and has an adequate view of the controls and of the actions of trainees sitting in said two trainee seats, while having tactile and visual access to said console.

19. A method as defined in claim 18 further comprising moving said instructor seat away from said two trainee seats so that the instructor sitting in said instructor seat assumes a remote observation position.

20. A method as defined in claim 19 further comprising the step of moving said console together with said instructor seat.
